(19) United States
(12) Patent Application Publication
(10) Pub. No.: US 2014/0180756 A1
(43) Pub. Date: Jun. 26, 2014

(54) Method and System for Modeling Workforce Turnover Propensity

(71) Applicant: Roth Staffing Companies, L.P., Orange, CA (US)

(72) Inventors: Robert Alan Hankin, Dana Point, CA (US); Ben Martin Roth, Fullerton, CA (US)

(73) Assignee: Roth Staffing Companies, L.P., Orange, CA (US)

(21) Appl. No.: 14/139,384

(22) Filed: Dec. 23, 2013

Related U.S. Application Data
(60) Provisional application No. 61/745,526, filed on Dec. 21, 2012.

(51) Int. Cl. G06Q 10/06

(52) U.S. Cl. CPC G06Q 10/0635
USPC 705/7.28

(57) ABSTRACT

Systems, methods and devices for modeling workforce turnover propensity is disclosed. The system can include a memory that stores instructions and a processor that executes the instructions to perform operations. The operations can include receiving questionnaire responses to a questionnaire that elicits a perception of employee turnover factors of a plurality of representatives, where the questionnaire responses are provided by one of company representatives, company workforce representatives or a combination thereof. The operations also can include selecting questionnaire responses of the representatives, calculating representative questionnaire scores and comparing the representative questionnaire scores to a statistical model. Further, the operations can include determining an employee turnover propensity based on comparing the representative questionnaire scores to the statistical model, where the employee turnover propensity indicates a likelihood that an employee will leave a particular job.

### FIELD OF THE INVENTION

The present application generally relates to modeling workforce turnover in a workplace and more particularly relates to a computer implemented system and method for modeling workforce turnover under a given set of circumstances or conditions.

### BACKGROUND

Companies require management of workforce needs based on a variety of factors, including the amount of work to be completed, the amount of time to complete the work and any particularized skill sets needed to complete the work. Companies occasionally utilize contingent workforces, or temporary staff, as part of the overall management of the company's workforce needs. The term, the length of employment, duration of employment or attrition of contingent workforce members, and even full time workforce members, however, is not uniform. The term can vary from industry to industry. Even within the same industries, the term of the employees can vary.

### SUMMARY

A system and accompanying methods and devices for modeling workforce turnover in a workplace are disclosed. A turnover propensity can be determined for any given company under that company's current conditions. This will help determine the likelihood that a given employee leaves before an assignment or job is completed. An average expected turnover can also be determined. The systems, methods and devices, can also help identify the perception of employee turnover conditions of the various company management levels, temporary workforce, and full-time workforce, and any other groups or levels at the company, and the collective perceptions of the company's hierarchical levels or groups. The system can also compare the perceptions of each hierarchical group to identify variances between the groups. A value or score can also be calculated for these perceptions. The value or score can be used by a statistical model to predict or calculate tendencies. Further, the value or score can be compared to a plurality of corresponding company values or scores.

Such determinations can help with multiple issues and to take corrective or preventative actions. For instance, staffing plans can be adjusted as appropriate based on turnover. Second, the contingent workforce provider and client of the contingent workforce provider can collaborate to address staffing needs before they arise and to maximize the efficiency of the current in-place staff, such as by reducing turnover.

The system can use questionnaires that elicit a perception of turnover propensity factors according to the perspective of various company representatives. These company representatives can be at different hierarchical levels within a company, including executives, hiring managers, line managers, full-time employees, and temporary employees. The responses to the questionnaires can be scored and compared to both the statistical model and corresponding company values. The statistical model produces or calculates a numeric value representative of the total company, which can be a score, and the model also produces or calculates a score for each hierarchical group.

Turnover propensities as compared to the statistical model can be obtained for each hierarchical group of scores and plausible tendencies can be determined from comparisons of these scores to the model. The hierarchical group of scores is a weighted average of all responses from each hierarchical level at the company. In addition, the overall turnover propensity as compared to the statistical model can be obtained for the overall company score and plausible tendencies can be determined from comparisons of this score to the model. The overall company score is a weighted average of all company responses.

By comparing the company's overall score to scores of corresponding companies, based on secondary data variables, a company's average expected turnover can be determined. This comparison can also include many secondary data variables, such as demographics, industry, geographic region, company size and company function, that can be used to broaden or limit the scope of the comparison. For example, an overall company score can be compared to other companies within the same city and the same industry that have a similar size. As an alternative example, an overall company score can be compared to other companies within the same industry across multiple cities that have the same city population size.

Further, the systems, methods and models can evolve over time as the questionnaire scores are saved and the model is recalculated over time. The responses to these saved questionnaires can also determine the relevancy of the various questions as they pertain to the model. The relevancy can then influence the weighting of each questionnaire response. This evolution of the model provides for a greater alignment between the model and the predicted or calculated tendencies.

In one embodiment, a system for modeling attrition in a workplace can include a memory that stores instructions and a processor that executes the instructions to perform operations. The operations can include receiving questionnaire responses to a questionnaire that elicits a perception of employee turnover factors of a plurality of representatives, where the questionnaire responses are provided by one of company representatives, company workforce representatives or a combination thereof. The operations also can include selecting questionnaire responses of the representatives, calculating representative questionnaire scores and comparing the representative questionnaire scores to a statistical model. Further, the operations can include determining an employee turnover propensity based on comparing the representative questionnaire scores to the statistical model, where the employee turnover propensity indicates a likelihood that an employee will leave a particular job.

In one arrangement, the company representative can be selected from the group consisting of an executive level employee, a hiring manager, a supervisor, and the company workforce representative can be selected from the group consisting of a contingent employee and a full-time employee.

In one arrangement, the operations can also include receiving questionnaire responses to the questionnaire that elicits a perception of employee turnover factors of a hierarchical group of company representatives, where the questionnaire responses are provided by a plurality of company representatives. The operations can also include selecting questionnaire responses of the hierarchical group of company representatives, calculating a hierarchical group questionnaire score, and calculating an overall company questionnaire score, comparing the hierarchical group questionnaire score and overall company questionnaire score to a statistical model. Still further the determining of an employee turnover propensity based on comparing the representative questionnaire scores to the statistical model can include determining an employee turnover propensity based on comparing the hierarchical group questionnaire score and overall company questionnaire score to a statistical model.

In another embodiment, the operations can also include comparing the overall company questionnaire score to corresponding company scores and determining an average expected turnover based on comparing the overall company questionnaire score to corresponding company scores. Also, the determining an average expected turnover further can include selecting an average expected turnover level from possible expected turnover averages associated with a range corresponding company scores. The average expected turnover can be the employee turnover that is likely to occur given current circumstances of the company.

In another arrangement, the operations can further comprise updating the statistical model based on a recalculation utilizing the company representative questionnaire score. Further the operations can comprise updating the statistical model based on a recalculation utilizing the calculated hierarchical group questionnaire score and the calculated overall company questionnaire score. Additionally, the operations can include updating the corresponding company scores with the questionnaire responses received from the company representative and recalculating the statistical model based on the updated corresponding company scores.

In another embodiment, the operations can include updating the corresponding company scores with the calculated hierarchical group questionnaire score and the calculated overall company questionnaire score, and calculating possible expected turnover averages associated with a range of corresponding company scores. The operations can also include identifying outcome determinative factors of the difference in the workforce created by the average expected workforce turnover and providing suggested changes, in response to identifying outcome determinative factors, to maintain a desired workforce.

Methods to perform certain operations are also provided herewith. A computer-readable device or medium comprising instructions, which when executed by a processor, cause the processor to perform certain operations is also provided herewith.

These and other features of the systems and methods for modeling workforce turnover propensity are described in the following detailed description, drawings, and appended claims.

### BRIEF DESCRIPTION OF THE DRAWINGS

FIG. 1 is a schematic illustration featuring a view a system for modeling workforce turnover in a workplace according to an embodiment of the present disclosure.

FIG. 2 is an exemplary questionnaire that elicits a perception of workforce turnover propensity and service level factors of a company representative according to the present disclosure.

FIG. 3 is another exemplary questionnaire that elicits a perception of workforce turnover propensity and service level factors of a company representative according to the present disclosure.

FIG. 4 is another exemplary questionnaire that elicits a perception of workforce turnover propensity and service level factors of a company representative according to the present disclosure.

FIG. 5 is another exemplary questionnaire that elicits a perception of workforce turnover propensity and service level factors of a company representative according to the present disclosure.

FIG. 6 is another exemplary questionnaire that elicits a perception of workforce turnover propensity and service level factors of a company representative according to the present disclosure.

FIG. 7 is another exemplary questionnaire that elicits a perception of workforce turnover propensity and service level factors of a company representative according to the present disclosure.

FIG. 8 is another exemplary questionnaire that elicits a perception of workforce turnover propensity and service level factors of a company representative according to the present disclosure.

FIG. 9 is another exemplary questionnaire that elicits a perception of workforce turnover propensity and service level factors of a company representative according to the present disclosure.

FIG. 10 is another exemplary questionnaire that elicits a perception of workforce turnover propensity and service level factors of a company representative according to the present disclosure.

FIG. 11 is another exemplary questionnaire that elicits a perception of workforce turnover propensity and service level factors of a company representative according to the present disclosure.

FIG. 12 is a flow diagram illustrating a sample method for modeling workforce turnover in a workplace according to the present disclosure.

FIG. 13 is a flow diagram illustrating a sample method for addressing workforce turnover according to the present disclosure.

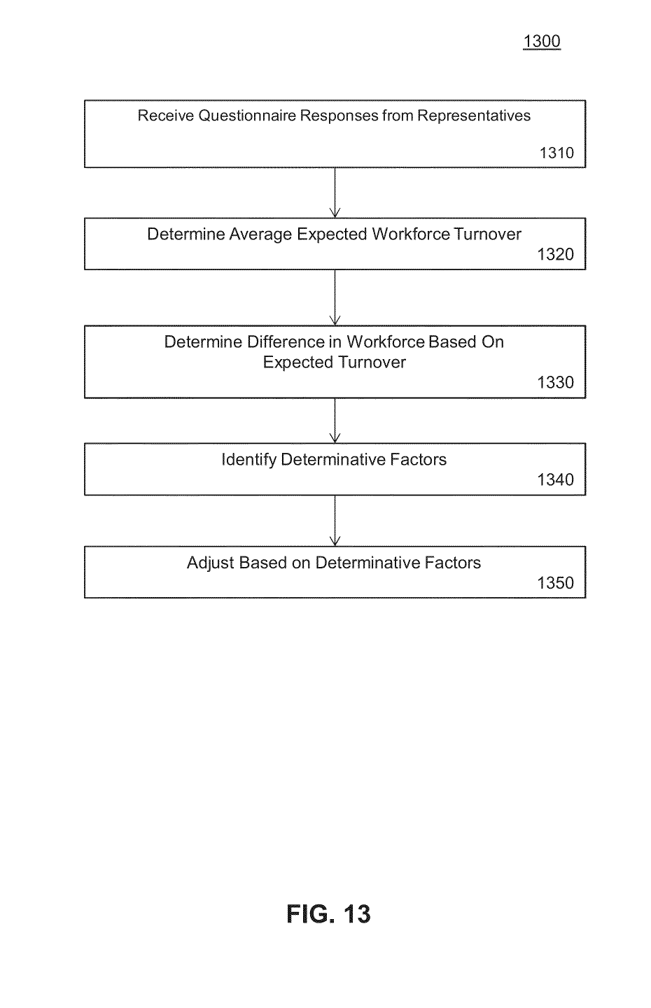

FIG. 14 is a diagrammatic representation of a machine in the form of a computer system within which a set of instructions, when executed, may cause the machine to perform any one or more of the methodologies discussed herein.

### DETAILED DESCRIPTION

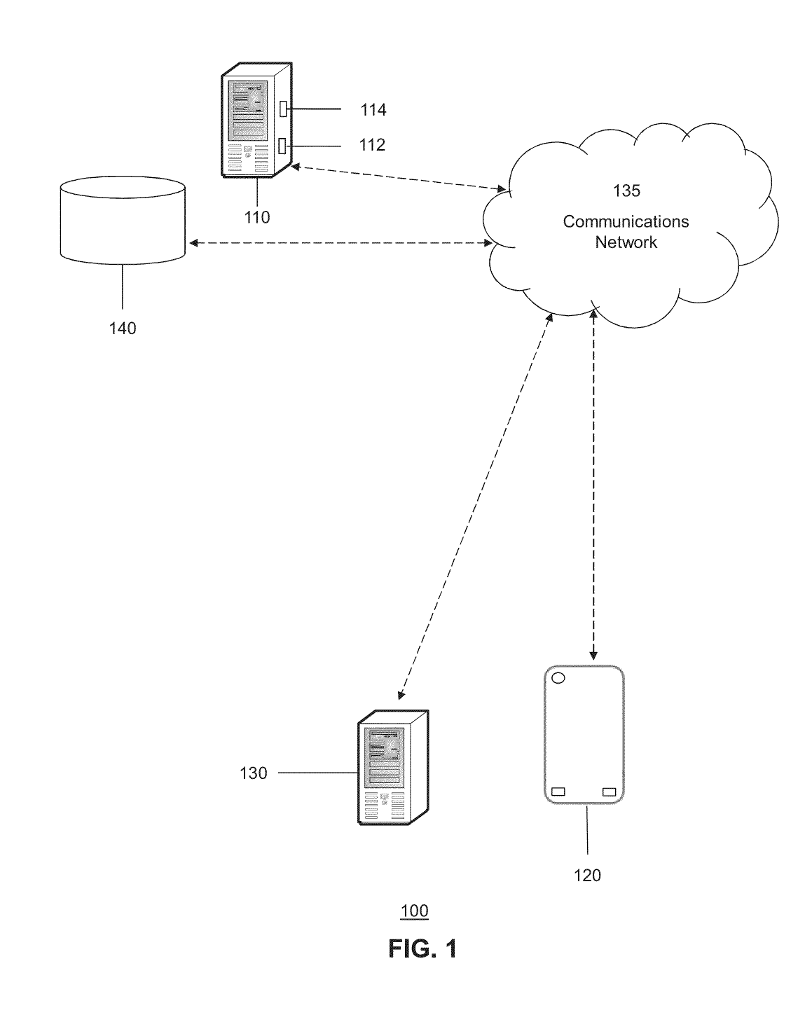

A system 100 for modeling workforce turnover in a workplace is disclosed in the present disclosure. Referring to the drawings and in particular to FIG. 1, the system 100 may enable a modeling server 110 to receive and process questionnaire responses from one or more employer representatives utilizing one or more devices 120, 130 to input questionnaire responses.

The server or device 110 may include one or more electronic processors 112, which may be configured to handle any necessary processing for carrying out any and all of various operative functions of the system 100. The electronic processors 112 may be software, hardware, or a combination of hardware and software. Additionally, the server 110 may also include a memory 114, which may be configured to store instructions that the electronics processors 112 may execute to perform various the operations of the system 100. For example, the server 110 may receive questionnaire response data from the company representative utilizing handheld device 120 and perform the necessary operations to compare company representative questionnaire scores to a statistical model, determine turnover propensities, select plausible turnover propensities, compare company representative questionnaire scores to corresponding company scores and other operations and functions discussed herein.

In one embodiment, multiple servers or devices 110 may be utilized to process the functions of the system 100. The server 110 or the device 110, or both, may utilize the database 140 for storing a plurality of stored previous employer responses, previous calculations and corresponding company turnover propensities, along with any other data that the devices in the system 100 may utilize in processing. In an embodiment, multiple databases 140 may be utilized to store data in the system 100. Notably, the system 100 may utilize a combination of software and hardware to perform the operative functions of the system 100 disclosed herein. Additionally, although FIG. 1 illustrates specific example configurations of the various components of the system 100, the system 100 may include any configuration of the components, which may include using a greater or lesser number of the components.

Furthermore, the communications network 135 may be any suitable network that may be utilized to allow the various components of the system 100 to communicate with one another. For instance, the communications network 135 may be a wireless network, an ethernet network, a satellite network, a broadband network, a cellular network, a private network, a cable network, the Internet, or any combination thereof.

The system and methods disclosed herein relate to modeling turnover propensities that will likely occur for a contingent or permanent workforce under a set of given circumstances. The turnover propensity provides insight into the likelihood that one or more temporary employees will not complete the intended or anticipated duration of temporary employment. The turnover propensity of a contingent workforce in a given set of current company circumstances may differ from a company's or client's expected turnover of its workforce. There can be company or client specific criteria or criterions used to determine a turnover propensity. The employee turnover propensity or tendency can indicate the likelihood that a contingent employee provided by a contingent workforce provider will complete the duration of an employment term given the company's current circumstances. The employee turnover propensity or tendency can also indicate the likelihood that a non-contingent employee will leave a company given the company's current circumstances. Accordingly, determining turnover propensities may provide a staffing service company with the ability to plan for future turnover and consistently provide a client's desired number of contingent employees for a particular assignment or project consistent with a timeline established by the client.

The system and methods disclosed herein include questionnaires and responses to the questionnaires from one or more company representatives. The questionnaire can include a variety of questions that relate to, and that do not relate to, a company representative's perception of employee turnover factors, including work conditions employee expectations, employee satisfaction, staffing level needs, benefits, expected service levels, and other employment and staffing issues. One or more combinations of employee turnover factors can be determinative of whether the contingent labor provider will be able to meet or exceed the client's expected staffing service level. Available answers to the individual questions within the questionnaire can include a numerical rating scale, such as a Likert-type scale. Answers to the individual questions within the questionnaire can also be numerical responses to questions, such as the number of average temporary employees. Further, answers to the individual questions within the questionnaire can include a ranking of order of importance of two or more pre-defined answers. Still further, answers to the individual questions within the questionnaire can include the selection of a single most accurate non-numerical answer from a list of possible non-numerical answers.

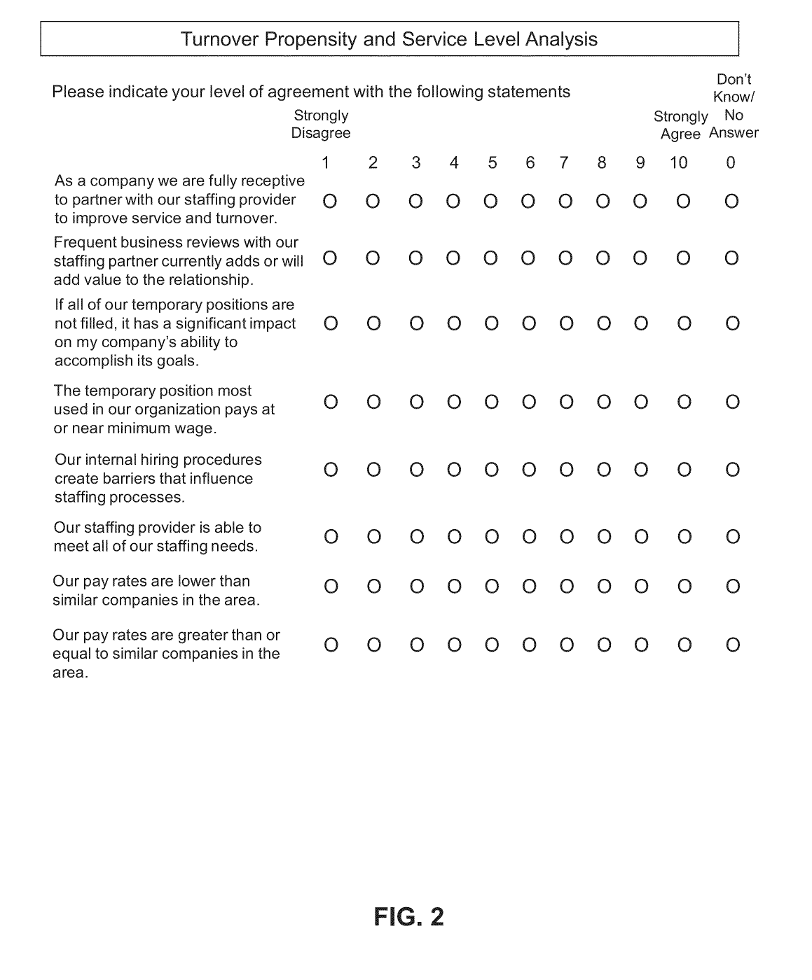

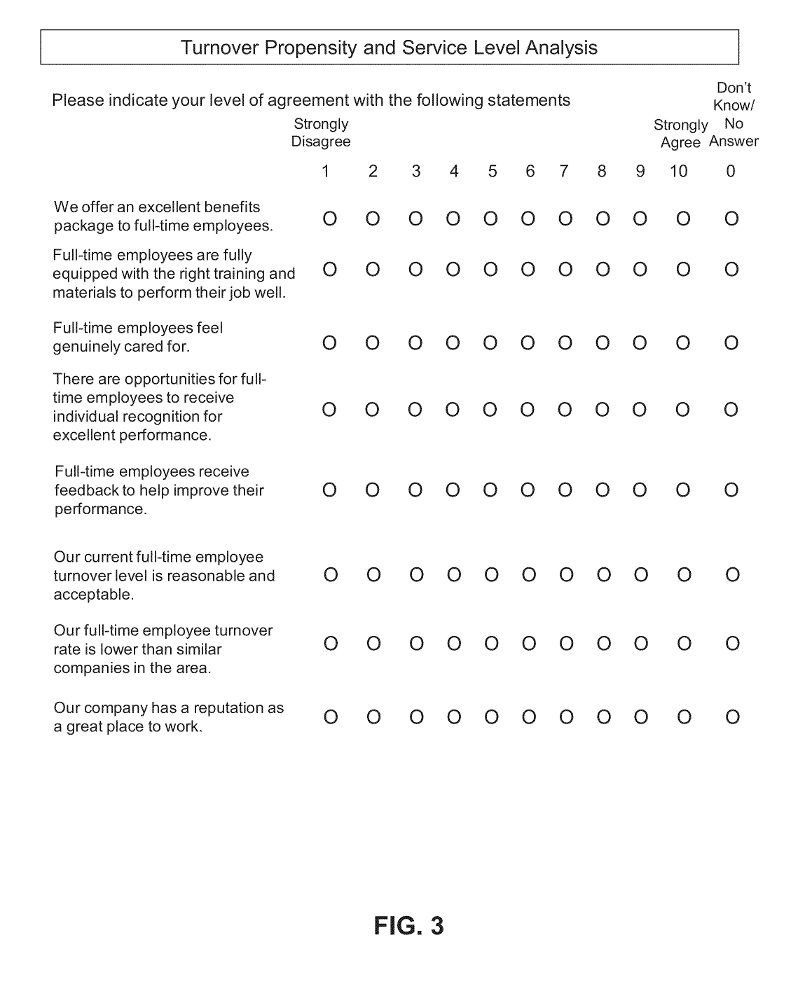

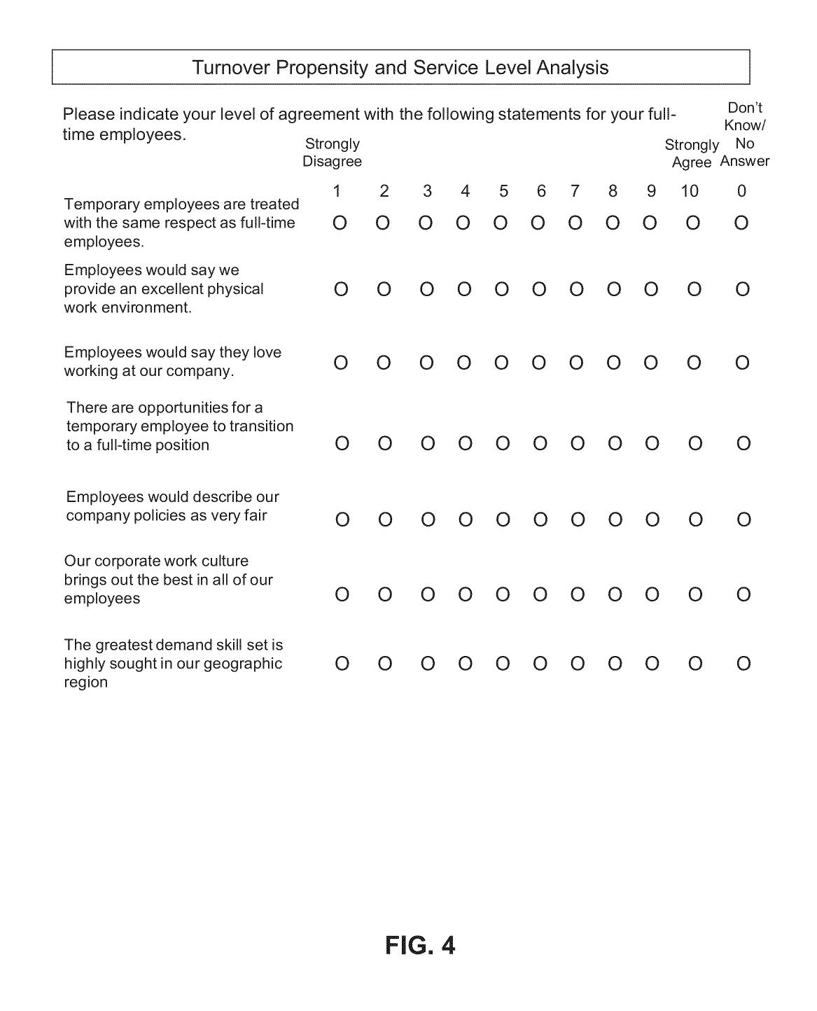

FIGS. 2-5 are exemplary questions and/or statements of questionnaires regarding an employer representative's perception of employee work condition factors and service level factors. The questions, however, are not limited to being designed to illicit a perception of employee work condition factors. For example, some questions can be included to determine a company representative's or a client's service level expectations. Other questions can be included to determine current demographic data. Other questions not related to staffing service levels can also be included.

As shown in FIGS. 2-4 include a ranking from 1-10 to indicate the company representative's agreement or disagreement with the statement. The company representative's response can include the degree to which the company representative agrees or the degree to which the company representative disagrees with the statement. For example, if the company representative strongly disagrees with the statement, the company representative can select the first response with a value of one. On the other hand, if the company representative strongly agrees with the statement, the company representative can select the response with a value of 10. The company representative can also select “Don't Know Answer” to indicate that the company representative does not know the answer to the question or statement. In one embodiment, the exemplary questionnaire can be implemented via a web page with appropriate toggle or radio buttons or the like for the company representative to select their answers to the individual questions. The answers can then be received by, for example, a webserver.

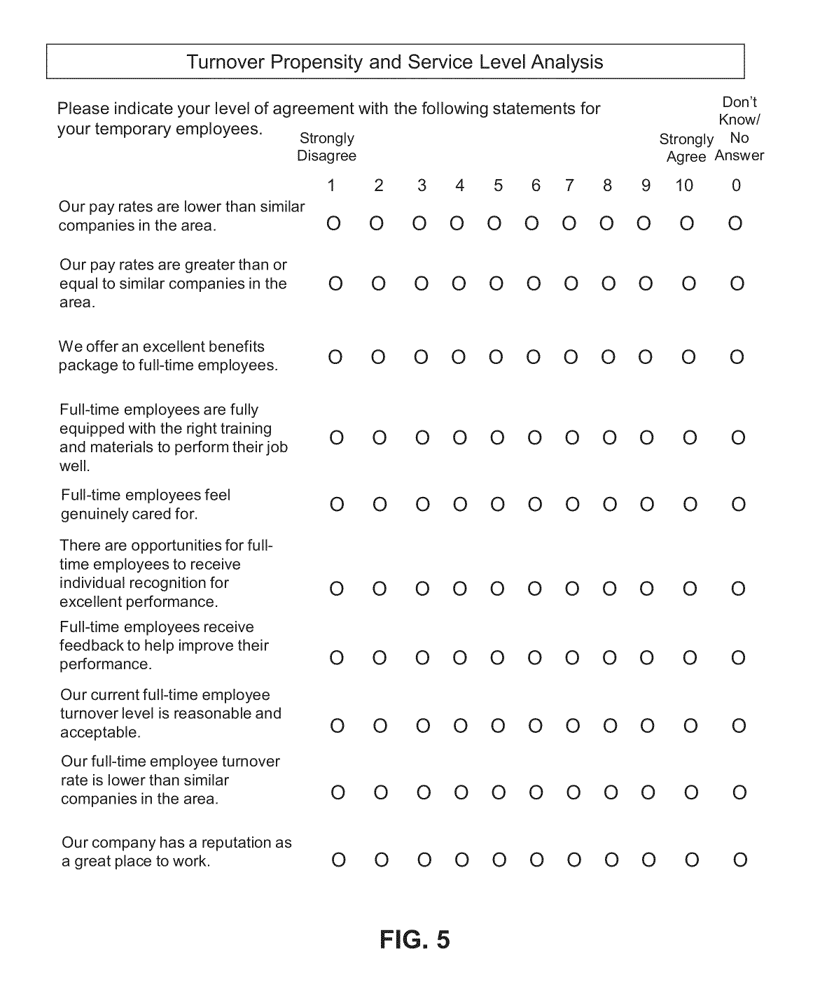

FIG. 5 includes additional statements regarding factors related to turnover propensity. The turnover propensity statements can provide insight into the likelihood that one or more temporary employees will not complete the intended or anticipated duration of temporary employment. The available answers to the statements in FIG. 5 include a ranking from 1-10 to indicate the company representative's agreement or disagreement with the statement. The company representative's response can include the degree to which the company representative agrees or the degree to which the company representative disagrees with the statement. Other exemplary questions or statements can include the following: temporary employees are treated with the same respect as full-time employees; employees would say we provide an excellent physical work environment; employees would say they love working at our company; there are opportunities for a temporary employee to transition to a full-time position; employees would describe our company policies as very fair; our corporate work culture brings out the best in all of our employees; the greatest demand skill set is highly sought in our geographic region; temporary employees are fully equipped with the right training and materials to perform their job well; temporary employees feel genuinely cared for; there are opportunities for temporary employees to receive individual recognition for excellent performance; temporary employees receive feedback to help improve their performance; our current temporary turnover level is reasonable and acceptable; our temporary employee turnover rate is lower than similar companies in the area; and pay rates for temporary employees similar to similar companies. Any combination of such questions may be utilized.

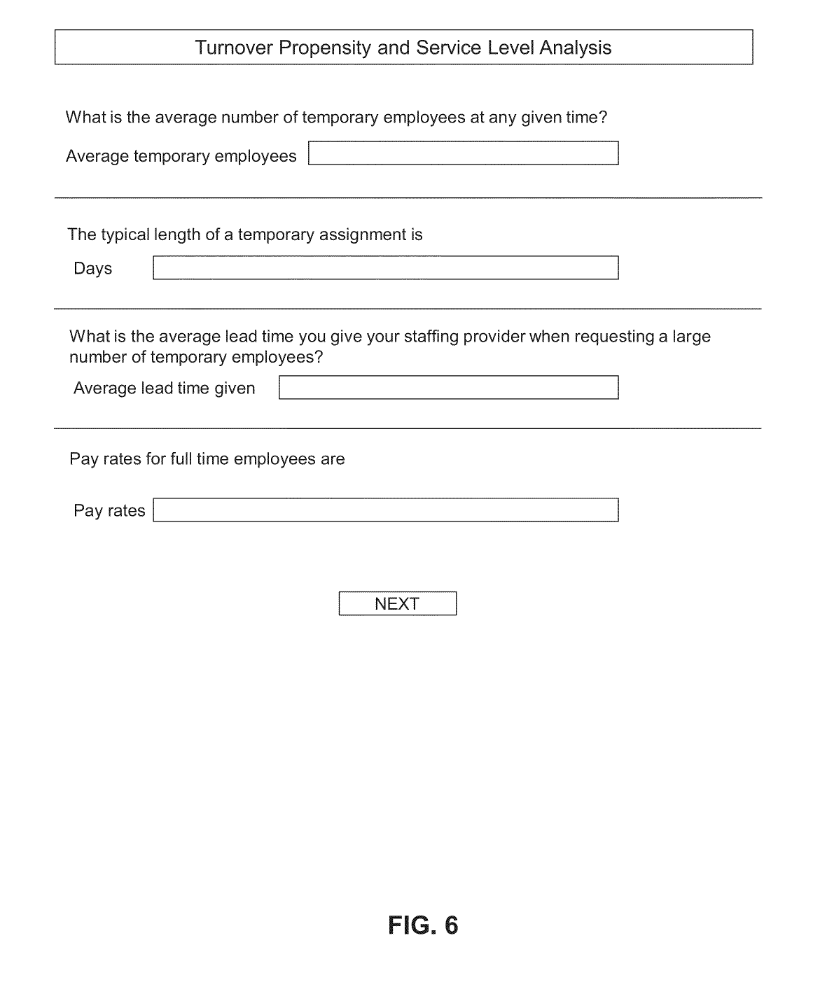

In one embodiment, the exemplary questionnaire can be implemented via a web page with appropriate toggle or radio buttons or the like for the employer representative to select their answers to the individual questions. The answers can then be received by, for example, a webserver. FIG. 6 illustrates additional exemplary questions for use in a questionnaire. The questions of FIG. 6 and its format for providing an answer are designed to elicit a numerical response to be provided by a user. For instance, the questions elicit the number of average temporary employees from an employer representative and the number of days of the typical length of a temporary assignment. Again, the exemplary questionnaire can be implemented via a web page with appropriate fields or the like for the employer representative to input their answers to the individual questions. The answers can then be received by, for example, a webserver.

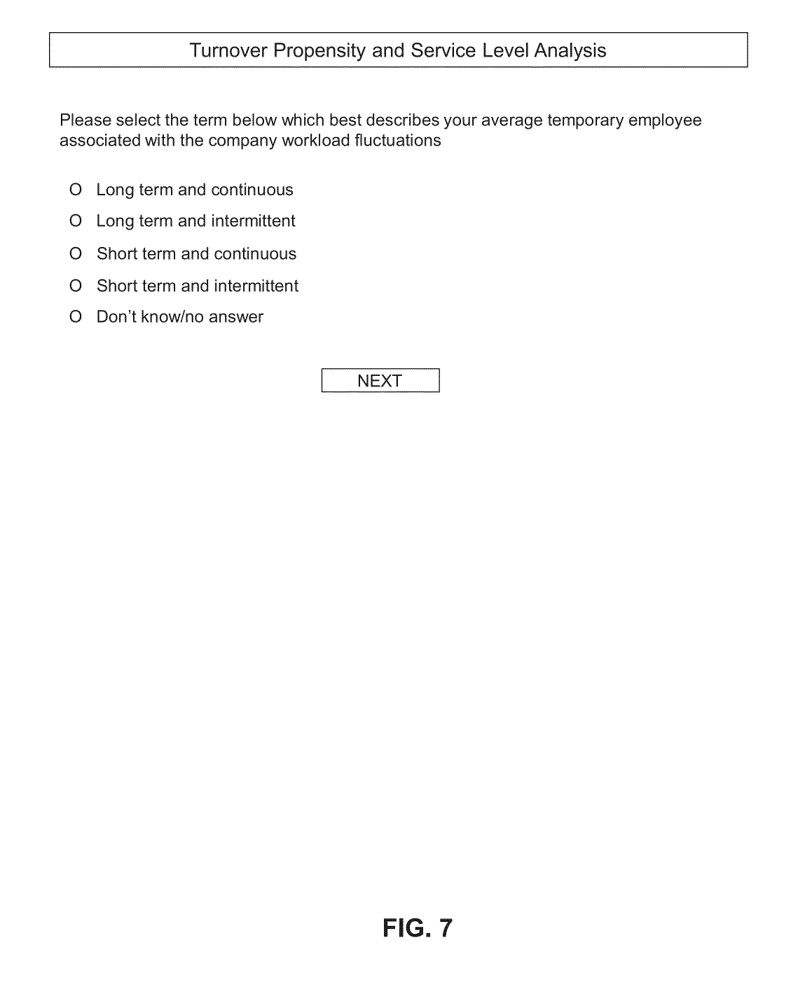

FIG. 7 illustrates a different embodiment of an additional exemplary question for use in a questionnaire. The questions of FIG. 7 include a list of possible answers that reflect a company representative's perception of average length of temporary employee employment and whether such employment is continuous or intermittent. Other questions with pre-populated answers can also be included. The exemplary questionnaire can be implemented via a web page with appropriate fields or the like for the company representative to input their answer(s) to the individual question(s). The answers can then be received by, for example, a webserver.

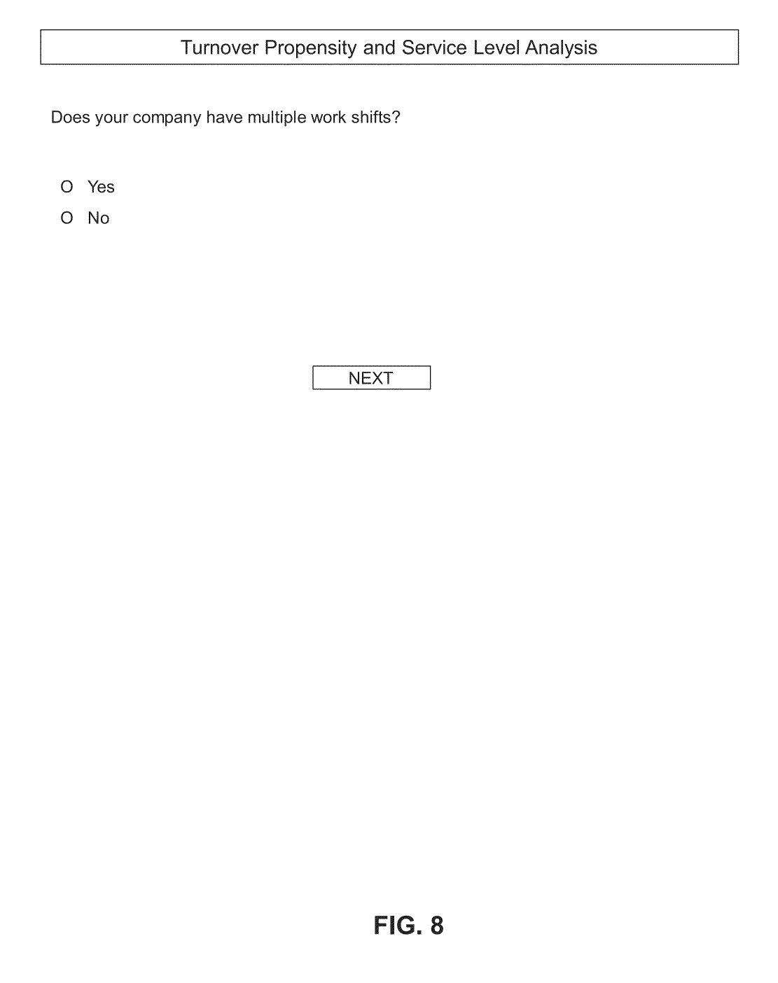

FIG. 8 illustrates yet another embodiment of an additional exemplary question for use in a questionnaire. The question of FIG. 8 includes a “yes” or “no” answer for selection by the company representative as their answer to the question. Other questions with “yes” or “no” answers, or “true” or “false” answers can also be provided. The exemplary questionnaire can be implemented via a web page with appropriate fields or the like for the employer representative to input their answer(s) to the individual question(s). The answers can then be received by, for example, a webserver.

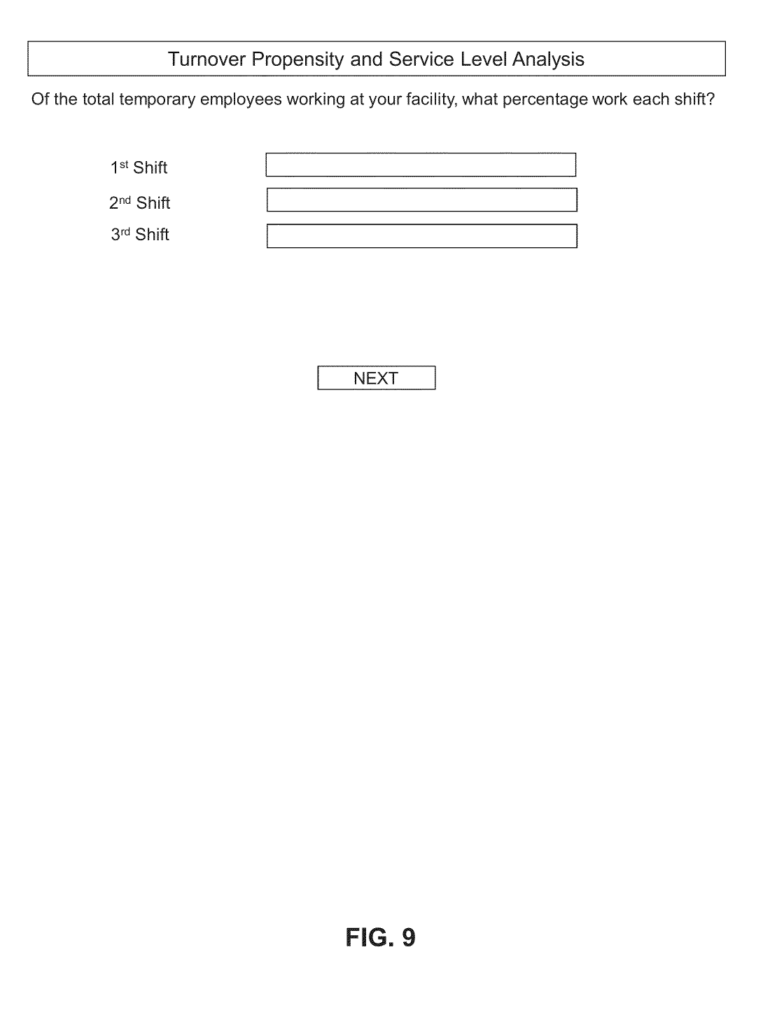

FIG. 9 illustrates yet another embodiment of an additional exemplary question for use in a questionnaire. The question of FIG. 9 is formatted to elicit a numerical value for the percentage of employees working at a particular employer during a particular shift. For instance, the employer representative can provide answers of 5%, 25%, 0% and 30%, respectively, for the first, second, third shift and total. The exemplary questionnaire can be implemented via a web page with appropriate fields or the like for the company representative to input their answer(s) to the individual question(s). The answers can then be received by, for example, a webserver.

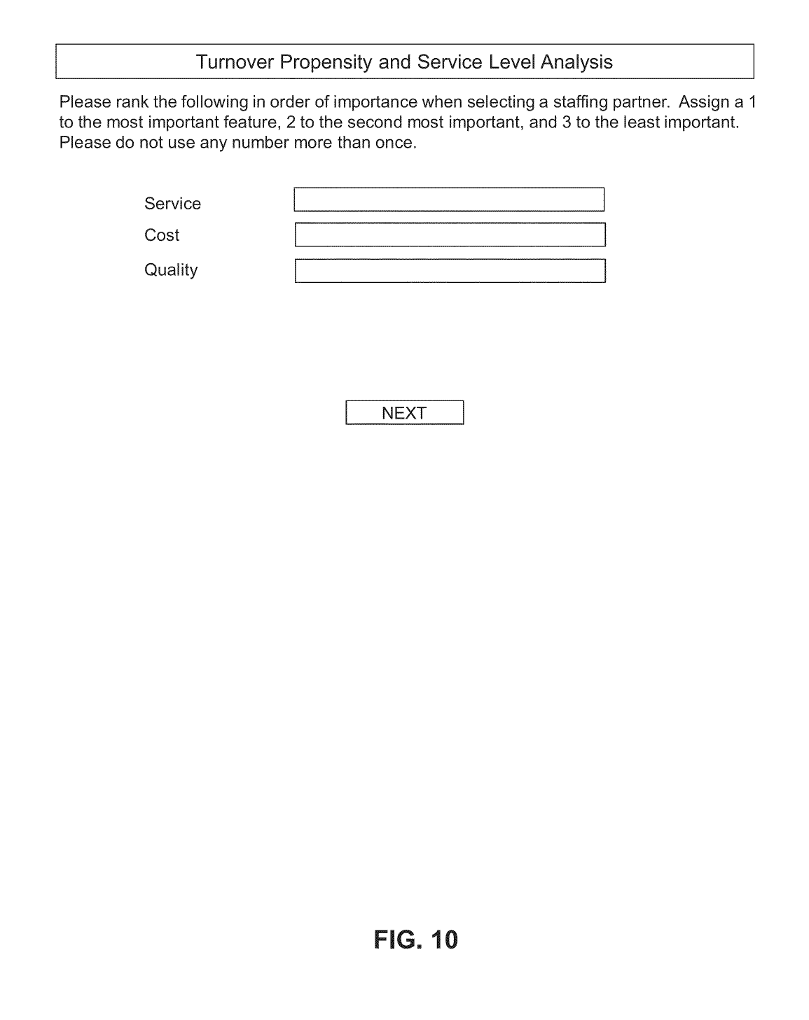

FIG. 10 illustrates yet another embodiment of an additional exemplary question for use in a questionnaire. The question of FIG. 10 is formatted to elicit a ranking of three qualities of importance to selecting a staffing partner. The factors are provided and the company representative can provide a ranking of first, second and third as appropriate. Again, the exemplary questionnaire can be implemented via a web page with appropriate fields or the like for the company representative to input their answer(s) to the individual question(s). The answers can then be received by, for example, a webserver.

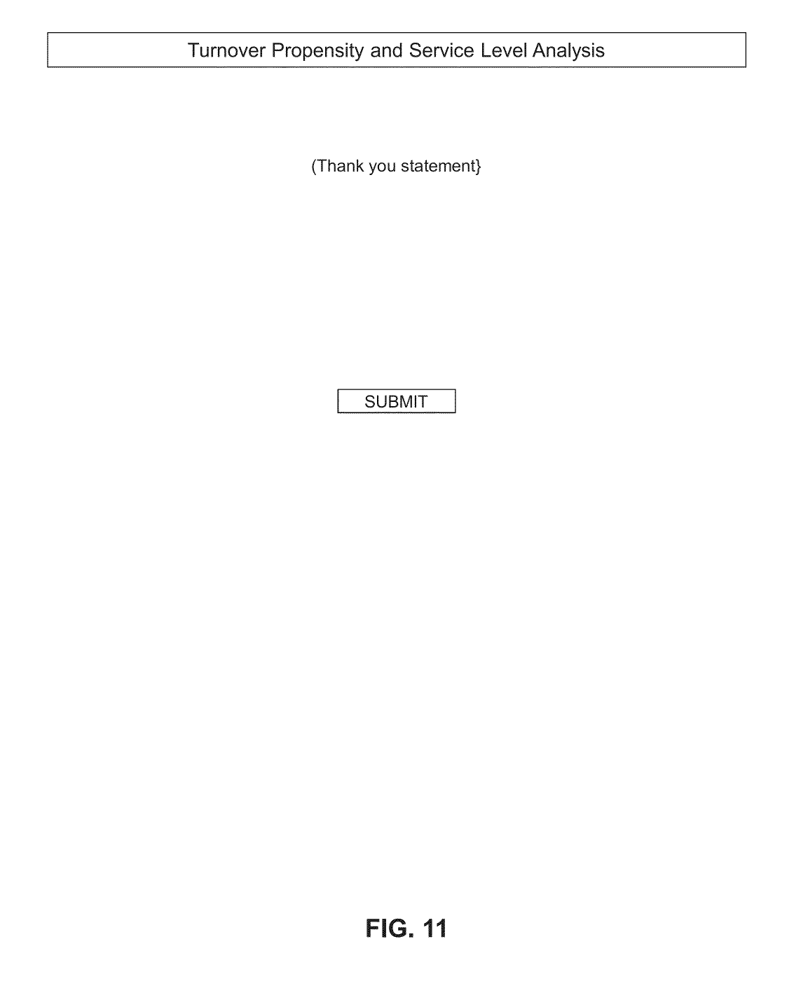

FIG. 11 illustrates an exemplary conclusion page to the questionnaire. The exemplary conclusion page illustrates that the questionnaire can be implemented via a web page and the employer representative can conclude the questionnaire by selecting the submit button. At this time, all of the company representative's answers can be submitted and then received, for example, via a web server. Alternatively, the answers can be submitted and received as soon as they are input by the employer representative.

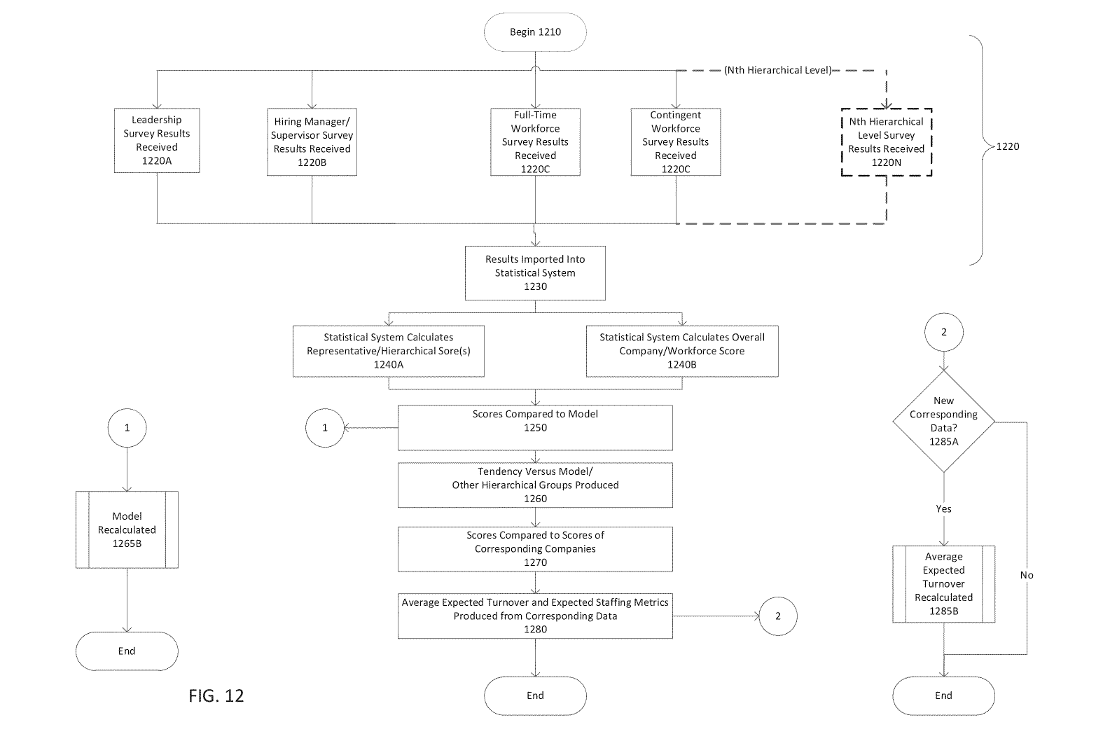

One embodiment of a method for modeling turnover propensity of a company seeking one or more temporary or contingent employees is illustrated in FIG. 12 as a flow diagram. The method 1200 for modeling turnover propensity can begin at 1210. At step 1220A, responses to one or more questionnaires can be received from one or more of company and company workforce representatives. The responses can be formatted in a data structure, such as utilizing extensible mark-up language, suitable for parsing the responses to individual questionnaire questions. The questionnaire can include any one or more combinations of the exemplary questions from FIGS. 2-11.

Step 1220A can be repeated one or more times to receive responses to a questionnaire from a plurality of company and company workforce representatives. Step 1220A represents an example of receiving one or more questionnaire responses from representatives of a company's executive leadership team, such as presidents and officers. Step 1220B represents an example of receiving one or more questionnaire responses from representatives of a company's hiring managers or supervisors. Step 1220C represents an example of receiving one or more questionnaire responses from representatives of a company's full-time workforce. Step 1220D represents an example of receiving one or more questionnaire responses from representatives of a company's contingent workforce. Step 1220E represents an example of receiving one or more questionnaire responses from any other type of company or company workforce representative. Further, steps 1220A-E can be grouped by hierarchical level within the company. In addition to individual representative scores, each hierarchical group can have a questionnaire score by averaging the scores from a particular hierarchical group. Further still, all responses can be grouped together to create an overall company score. The system and method are not limited in the number of company or permanent or temporary workforce representatives from which questionnaire responses can be received. Of all the responses received, certain questionnaire responses can be selected, which can include all of the responses received.

At step 1230, all questionnaire responses received are imported for analysis with a statistical system or software, such as SPSS Predictive Analytics software. This process can utilize a webserver, outputting a formatted data structure from a database containing all questionnaire responses, such as utilizing extensible mark-up language or a comma-separated values file, for utilization by the statistical system or software.

Step 1240A is an example of where a hierarchical group's questionnaire score can be calculated. The calculation can include any appropriate formulae for providing one or more numerical values based on the answers to the questionnaire(es). As an example, the calculation can be the summation of the numerical values selected by the company representative or grouping of company representatives, where any non-numerical answers are correlated to a numerical value, for instance, on a scale of 1-10. Thus, in some instances, a hierarchical group's questionnaire score can be based on the answers of a single representative. Also, if the score of more than one company representative is utilized, the scores can be averaged by the number of company representative scores that is utilized.

Alternatively, the calculation can be provided via SPSS Predictive Analytics software. A correlation analysis may be performed to look for a relationship between the employee turnover propensity factors. A multivariate regression allowing for multiple dependent variables may be completed using a variety of statistical techniques to identify certain employee turnover propensity factors that uniquely and significantly contribute to the formula. Once the employee turnover propensity factors for the model are selected, the individual regression coefficients may be determined using the least squared method. With the employee turnover propensity factors for the model, a factor analysis may be performed to identify groupings of employee turnover propensity factors and the associated factor loadings. A statistical employee turnover propensity factor is constructed from groupings of variables with interdependent variability. Factor loadings are coefficients where the squared factor loadings show the percent of variance in that indicator variable explained by the factor. The processor and memory may be configured to utilize the following algorithms to calculate the score.

$$Correlation Analysis \text{:}$$

$${s}_{x}^{2} = \frac{\sum {x}^{2} - \frac{{( \sum x )}^{2}}{n}}{n - 1} = \frac{SS ( x )}{n - 1}$$

$$Mulitvariate Regression model \text{:}$$

$${Y}^{′} i = b 0 + b 1 X 1 i + b 2 X 2 i + … bnXni$$

$$Least Squares Model \text{:}$$

$$f ( {x}_{i} , β ) = {\sum }_{j = 1}^{m} {β}_{j} {φ}_{j} ( {x}_{i} )$$

$$where the coefficients , {φ}_{j} , are functions of {x}_{i} . \\ Letting$$

$${X}_{ij} = \frac{\partial f ( {x}_{i} , β )}{\partial {β}_{j}} = {φ}_{j} ( {x}_{i} ) . \\ where \hat{β} = {( {X}^{T} X )}^{- 1} {X}^{T} y .$$

### Factor Analysis

Suppose we have a set of P observable random variables χ₁, . . . ,χₚ with means μ₁, . . . , μ₂p ,
Suppose for some unknown constants lᵢⱼ and κ unobserved random varibles Fⱼ, where

iε1, . . . ,p and jε1, . . . , κ, where κ<p, we have

xᵢ−μᵢ=lᵢ₁F₁+lᵢₖF_{κ}+εᵢ.

Here, the εᵢ are independently distributed error terms with zero means and finite variance, which may not be the same for all i. Let Var(εᵢ=ψᵢ, so that we have

Cov(ε)=Diag(ψ₁, . . . , ψₚ)=ψ and E(ε)=0

In matrix terms, we have

χ−μ=LF+ε.

If we have η observations, then we will have the dimensions χ_{pxχ}, L_{p×κ}, and F_{κ×η}. Each column of χ and F denote values for one particular observation, and matrix L does not vary across observations
Also we will impose the following assumptions on F.
1. F and ε are independent.
2. E(F)=0
3. Cov(F)=I (to make sure that the factors are uncorrelated)
   Any solution of the above set of equations following the constraints for F is defined as the factors, and L as the loading matrix.
   Suppose Cov(χ−μ)=Σ. Then note that from the conditions just imposed on F, we have

Cov(χ−μ)=Cov(LF+ε),

or

Σ=LCov(F)L^{T}+Cov(ε),

or

Σ=LL^{T}+ψ

Note that for any orthogonal matrix Q if we set L=LQ and F=Q^{T}F, the criteria for being factors and factor loadings still hold. Hence a set of factors and factor loadings is identical only up to orthogonal transformations.

A matrix based on N observations of responses to questionnaire questions correlated to observed turnover from past engagements can be used to identify determinative employee turnover propensity factors.

At step 1250, the representative questionnaire scores of steps 1240A-B can be compared to a statistical model that provides statistics of employee turnover and employee turnover propensity, either rendered or expected, or both, of past rendered services or past questionnaire scores. The statistical model can be segregated into a plurality of statistical model scores correlated to demographic data, such as average income, average education, and the unemployment rate, availability of employees based on the job/industry, total population in the geographic area of the client, how many companies in the area are similar to the client (e.g. classified by NAICS code). The demographic data can be based on geography, industries or other categories. Thus, there can be a plurality of statistical model scores correlated to industry, geographic region or other correlation. The aggregation of the statistical model scores can produce a statistical model average score for any correlation chosen. Further, the statistical model average score can also be correlated to the title or level of the company representatives, or hierarchical groupings (e.g., statistical model averages for CEOs, CFOs, etc.) such that different statistical model average scores can be calculated based on the title or level of the company representatives or hierarchical groupings that answered the questionnaire.

In comparing the hierarchical or overall company questionnaire scores of steps 1240A-B to the appropriate statistical model average score, the hierarchical or overall company questionnaire scores can be greater than or less than the statistical model average score. The hierarchical or overall company questionnaire score being greater than or less than the statistical model average score can indicate the turnover propensity as determined in step 1260.

In step 1260, and based on comparing the hierarchical or overall company questionnaire scores to the appropriate statistical model average, a turnover propensity can be determined. The employee turnover propensity or tendency can indicate the likelihood that a contingent employee provided by a contingent workforce provider will complete the duration of an employment term given the company's current circumstances. The employee turnover propensity or tendency can also indicate the likelihood that a non-contingent employee will leave a company given the company's current circumstances. The tendency or propensity can also indicate if the contingent workforce provider can provide a workforce at the appropriate times such that the level of services that will or are likely to be rendered will be below, at or above the expected staffing service level or expected turnover. For instance, if the hierarchical or overall company questionnaire score is greater than the statistical model average, the difference between the hierarchical or overall company questionnaire score and the statistical model average can be used to determine an employee turnover propensity. Accordingly, the employee turnover propensity can be a percentage of likelihood that an employee, contingent or otherwise, will leave a particular assignment or job. For instance, if the statistical model average score for the chosen corresponding company variables is 75 and the hierarchical or overall company questionnaire score is 82, the difference between the two is 7. The difference of 7 can be used to calculate a certain percentage likelihood that any employee is likely to leave or stay with a particular job or assignment.

With the turnover propensity determined, the method can end at step 1260. Nevertheless, the hierarchical or overall company questionnaire score can also be saved in step 1265A shown as breakout reference 1. Also, each representative score can be saved over time to continuously build a database of scores. Alternatively, only selected representative scores can be saved over time for inclusion with the database of scores. With each new company or company workforce representative questionnaire score, the model average can be recalculated in step 1265B. Again, there can be one or more statistical model average scores based on, for example, demographic data, and a particular statistical model average score can be recalculated when a representative score that is correlated to the particular demographic data is calculated.

The method can also include comparing hierarchical or overall company questionnaire scores to scores of corresponding companies in step 1270. The comparison can include identifying corresponding companies with the same score as the hierarchical or overall company questionnaire score, or scores within a standard deviation. For instance, scores within a standard deviation value of 1, 2, 3 or so on can be considered similar. The corresponding company scores can also be segregated into a plurality of corresponding company scores correlated to demographic data, such as average income, average education, and the unemployment rate, availability of employees based on the job/industry, total population in the geographic area of a respective client, how many companies in the area are similar to the client (e.g. classified by NAICS code). The demographic data can be based on geography, industries or other categories. Thus, there can be a plurality of corresponding company scores correlated to industry, geographic region or other correlation. For example, a corresponding company score can be specific to a particular industry such that different industries can have different corresponding company scores. Further, the corresponding company scores can also be correlated to the title or level of the company representatives, or hierarchical groupings (e.g., statistical model averages for CEOs, CFOs, etc.) such that different corresponding company scores can be calculated based on the title or level of the company representatives or hierarchical groupings that answered the questionnaire.

A step 1280, and based on comparing the hierarchical group or overall company questionnaire score to the scores of corresponding companies of step 1270, an average expected turnover can be determined. The average expected turnover is based on actual turnover rates and the number of individuals who left employment from past employment and any appropriate staffing metrics of the past. The hierarchical group or overall company questionnaire score can be compared to corresponding company scores and the actual turnover rates, turnover numbers and staffing metrics for each corresponding company can be obtained. The average expected turnover is a plausible amount of turnover that can be expected based on a correlation to actual past turnover rates and numbers with the same representative or hierarchical scores or representative or hierarchical scores within a standard deviation.

The average expected turnover can be determined by selecting an average turnover from plausible turnover averages associated with a range of corresponding company scores. For instance, the corresponding company scores can be provided in ranges correlated to actual past staffing turnover averages. Thus, the average expected turnover can be correlated to actual turnover from past projects or engagements. As an example, the corresponding company scores may indicate that the average employee turnover associated with scores in the range of scores of 70-75 are correlated to an average expected employee turnover of 80. The range can be smaller, such that each range is a single score or unit, and the range can be greater, such as range of 10 or 15 or even higher.

With the average expected turnover determined, the method can end. However, the method can also provide the hierarchical group or overall company questionnaire score along with staffing metrics data from an entity resource planning database of actual employee turnover associated with the hierarchical group or overall company questionnaire score. The combination of the hierarchical group or overall company questionnaire score and the actual employee turnover associated with the hierarchical group or overall company questionnaire score can be input into a database of corresponding company scores. The average expected employee turnover for the range of corresponding company scores can be updated over time in process 1285A-B as the actual employee turnover data is correlated to the hierarchical group or overall company questionnaire scores. Further, an employer or staffing company ERP database can store actual staffing needs realized for a particular assignment and correlate those to previous employer representative staffing scores. The updated average expected employee turnover data can be used for the next determination of an average expected employee turnover.

In another embodiment, the scores with the same or similar actual realized staff deployment and turnover can be arranged or grouped in ranges. For instance, the ranges may be in increments of, for example 5, such that scores from 61-65 all have the same average expected turnover. If a company representative score falls within the 61-65 example range above, then an average expected turnover would be provided for that particular score. To illustrate further, a second company representative score of a different number but still falling within the same range would still determine the same average expected turnover. And, over time, the average expected turnover ranges would be re-calculated and redistributed with certain ranges by correlating the questionnaire scores to actual deployed staffing levels and turnover, such as in process 1285.

As indicated above, the system and method is arranged such that more than one company representative score can be received and used. In the discussion above, an executive level company representative's questionnaire responses can be received at step 1220A. For instance, the executive level can be a CEO, CFO or generally any employee that can sign a contract for the employer to partner with a staffing company.

On the other hand, the method also includes receiving questionnaire responses from a other company representatives, such as at step 1220B, where a non-executive level employee of the company, in this case a hiring manager or supervisor responds to the questionnaire. Generally, the hiring manager or supervisor would be an employee who is in immediate contact with or will otherwise work directly with temporary employees or staff.

The method also includes receiving questionnaire responses from a temporary staff or contingent workforce representative at step 1220D, where the temporary staff or contingent workforce representative is not a full-time employee of the company but is a temporary employee or contingent worker.

The questionnaire for the questionnaire responses received at step 1220D can be the same as, or different than the questionnaire for other company representatives discussed above. Nevertheless, the format of the questions will be the same such that a score can be calculated in step 1240A-B. Just like above, one or a combination of the questions from the questionnaire can be selected for use in the calculation step 1240A-B.

In step 1240A-B, the contingent workforce representative questionnaire score can be calculated. Again, the calculation is the same calculation discussed above with respect to step 1240A-B.

Moving to step 1250, the contingent workforce representative questionnaire score can be compared to a statistical model average score. The statistical model average score can be a single statistical model average score for the method, or as discussed above, the statistical model average score can be a statistical model average score correlated to the type of temporary staff or contingent worker providing responses, by demographics, skill set, length of temporary employment, or another correlation, to the questionnaire.

Again, based on a comparison of the contingent workforce representative questionnaire score to a statistical model average score, an employee turnover propensity can be determined in step 1250.

In instances where a plurality of hierarchical groups of company and/or company workforce representatives respond to the questionnaire, a comparison of the scores between the groups, as seen in step 1260, can also be performed. This comparison can determine tendencies, or percentage likelihoods, or variances between the turnover expectations of the various company hierarchical groups. These tendencies or variances can be used to trigger communications and promote dialog concerning a contingent staffing engagement or can influence, or can be used to alter, determinative factors that can affect the turnover propensity for any employee, contingent or otherwise.

The questionnaire for the questionnaire responses received at steps 1220A-E can be the same as, or different than the questionnaires for the other company or company workforce representatives. Nevertheless, the format of the questions will be the same such that a score can be calculated in step 1240A-B. Just like above, one or a combination of the questions from the questionnaire can be selected for use in the calculation step 1240A-B

In step 1280, an average expected turnover can be determined by selecting from any combination or groupings on questionnaire responses. Alternatively, a plurality of the determined average expected turnover can themselves be averaged to determine a combined average expected turnover. The average expected turnover can provide a benchmark against which the expected employee turnover can be managed as discussed below.

The calculations and determinations can be utilized to increase service levels of an employee provider, contingent or otherwise, as shown in the method 1300. In step 1310, as also discussed above with reference to method 1200, questionnaire responses can be received from one or more company representatives. An example would be the partners of a medical practice answering the questions as it relates to their contingent workforce needs. Questionnaire responses could be received from a doctor of the medical practice as a company representative. Once questionnaire responses are received, one or more of the calculations or determinations discussed with respect to FIG. 12 can be obtained.

At step 1320, after the questionnaire responses have been received from step 1310, the responses can be scored based on the statistical model as discussed above. The scores may then be used to determine the average expected workforce turnover. Likewise, using the medical practice example, all partners of the medical practice can provide questionnaire responses in step 1310 and can be grouped by their hierarchical level. The hierarchical group questionnaire responses can be scored based on the statistical model, determining the average expected employee turnover based on the overall hierarchical group. Likewise again, this process can be repeated for all hierarchical groups at the medical practice, which can be used to create an overall firm or company score for use in determining likely turnover.

At step 1330, the difference in contracted workforce and actual workforce based on expected turnover can be determined. The potential impact therefrom can also be determined. For instance, a company that engages a contingent workforce provider can indicate that they seek a certain number of employees with a certain skill level for a project time period that starts on a certain day. Using the example above, the medical practice could request a contingent workforce provider to provide 10 physician assistants with radiology experience for a six month project that starts within one month. Based on the expected turnover, some attrition of the workforce may be expected. Such attrition may affect the level of service provided by the contingent workforce provider. With the average expected workforce turnover determined in step 1330, impact on staffing service levels given the company's current circumstances can be analyzed. The differences may be great or small.

At step 1340, one or more factors that are determinative of the difference in the workforce created by the average expected workforce turnover can be identified. The determinative factors can be any one or more of the employee turnover factors. As non-limiting examples, the determinative factors may be: whether if all of the temporary positions are not filled, it has a significant impact on the company's ability to accomplish its goals; whether the internal hiring procedures create barriers that influence staffing processes; whether the staffing provider is able to meet all of the company's staffing needs; whether temporary employees are treated with the same respect as full-time employees; and/or pay rates for temporary employees compared to similar companies. The determinative factors can be identical to one or more of the questions in the questionnaires. Alternatively, the determinative factors can be a factor or circumstance derived from one or more employee turnover factors from the questionnaire. The determinative factors may also be related to demographic data, such as demographic data for a particular region. The determinative factors can be identified by statistically analyzing the questionnaire responses with respect to the data of corresponding companies. For example, corresponding company data may be staffing metrics of a company with variables similar to the client with a similar average expected turnover or similar average expected turnover. These metrics may include observed average length of assignment. Numerical analyses can be performed to identify one or more factors that are outcome determinative.

At step 1350, and based on the identification of outcome determinative factors, the number employees can be increased to meet or exceed a client's expectation. Alternatively or in combination, the timing of providing contingent workforce can be adjusted to ensure the proper number of employees throughout an engagement. Additionally, turnover can be managed based on the identification of determinative factors. For instance, if a determinative factor for the average expected turnover is the pay rate for temporary employees compared to corresponding companies, and the pay rate is identified as lacking in comparison to corresponding companies, the pay rate can be increased. As another example, a determinative factor may be whether temporary employees are treated with the same respect as full-time employees, the contingent workforce provider and the client can cooperate to ensure that temporary employees are treated with the same respect as full-time employees. Thus, in response to identifying outcome determinative factors, suggested changes can be provided by the contingent workforce provider to the company. These changes can help maintain the desired workforce, both in duration and in number. The suggested changes can include a report format listing the outcome determinative factor. The report can also include an indication of the impact of the outcome determinative factor on the expected turnover. Addressing these particular critical factors in these manners can ensure that contingent workforce meets its desired levels. The scores create multiple discussion points, backed by numerical data, beyond hiring decisions and decisions of whether or not to use contingent labor. They enable meaningful discussions with a numerical analysis to improve aspects of contingent and permanent labor issues.

It is important to note that the methods described above may incorporate any of the functionality, devices, and/or features of the systems described above, or otherwise, and are not intended to be limited to the description or examples provided herein.

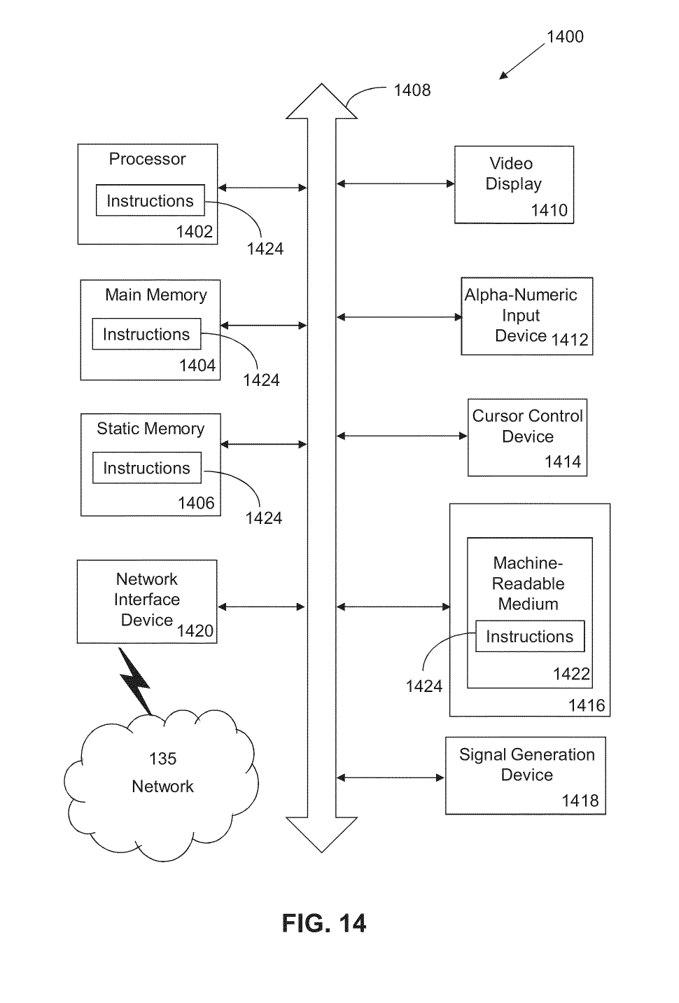

Referring now also to FIG. 14, at least a portion of the methodologies and techniques described with respect to the exemplary embodiments can incorporate a machine, such as, but not limited to, computer system 1400, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100.

In some embodiments, the machine operates as a standalone device. In some embodiments, the machine may be connected (e.g., using a network 135) to and assist with operations performed by other machines, such as, but not limited to, the device 110, the server 140, the database 145, or any combination thereof. The machine may be connected with any component in the system 100. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1400 may include a processor 1402 (e.g., a central processing unit (CPU), a graphics processing unit (GPU, or both), a main memory 1404 and a static memory 1404, which communicate with each other via a bus 1408. The computer system 1400 may further include a video display unit 1410 (e.g., a liquid crystal display (LCD), a flat panel, a solid state display, or a cathode ray tube (CRT)). The computer system 1400 may include an input device 1412 (e.g., a keyboard), a cursor control device 1414 (e.g., a mouse), a disk drive unit 1416, a signal generation device 1418 (e.g., a speaker or remote control) and a network interface device 1420.

The disk drive unit 1416 may include a machine-readable medium 1422 on which is stored one or more sets of instructions 1424 (e.g., software) embodying any one or more of the methodologies or functions described herein, including those methods illustrated above. The instructions 1424 may also reside, completely or at least partially, within the main memory 1404, the static memory 1406, or within the processor 1402, or a combination thereof, during execution thereof by the computer system 1400. The main memory 1404 and the processor 1402 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium 1422 containing instructions 1424 so that a device connected to the communications network 135 can send or receive voice, video or data, and to communicate over the network 135 using the instructions. The instructions 1424 may further be transmitted or received over the network 135 via the network interface device 1420.

While the machine-readable medium 1422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. In one embodiment, the machine readable storage medium may be a machine readable storage device. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below. cm We claim:

1. A system for modeling attrition in a workplace, comprising:
a memory that stores instructions; and
a processor that executes the instructions to perform operations, the operations comprising:
receiving questionnaire responses to a questionnaire that elicits a perception of employee turnover factors of a plurality of representatives, wherein the questionnaire responses are provided by one of company representatives, company workforce representatives or a combination thereof;
selecting questionnaire responses of the representatives;
calculating representative questionnaire scores;
comparing the representative questionnaire scores to a statistical model; and
determining an employee turnover propensity based on comparing the representative questionnaire scores to the statistical model, wherein the employee turnover propensity indicates a likelihood that an employee will leave a particular job.

2. The system of claim 1, wherein the company representative can be selected from the group consisting of an executive level employee, a hiring manager, and a supervisor; and
wherein the company workforce representative can be selected from the group consisting of a contingent employee and a full-time employee.

3. The system of claim 2, wherein the operations further comprise:
receiving questionnaire responses to the questionnaire that elicits a perception employee turnover factors of a hierarchical group of company representatives, wherein the questionnaire responses are provided by a plurality of company representatives;
selecting questionnaire responses of the hierarchical group of company representatives;
calculating a hierarchical group questionnaire score;
calculating an overall company questionnaire score;
comparing the hierarchical group questionnaire score and overall company questionnaire score to a statistical model; and
wherein determining an employee turnover propensity based on comparing the representative questionnaire scores to the statistical model includes determining an employee turnover propensity based on comparing the hierarchical group questionnaire score and overall company questionnaire score to a statistical model.

4. The system of claim 3, wherein the operations further comprise:
comparing the overall company questionnaire score to corresponding company scores; and
determining an average expected turnover based on comparing the overall company questionnaire score to corresponding company scores.

5. The system of claim 4, wherein determining an average expected turnover further comprises selecting an average expected turnover level from possible expected turnover averages associated with a range corresponding company scores.

6. The system of claim 5, wherein the average expected turnover is the employee turnover that is likely to occur given current circumstances of the company.

7. The system of claim 1, wherein the operations further comprise updating the statistical model based on a recalculation utilizing the company representative questionnaire score.

8. The system of claim 1, wherein the operations further comprise updating the statistical model based on a recalculation utilizing the calculated hierarchical group questionnaire score and the calculated overall company questionnaire score.

9. The system of claim 4, wherein the operations further comprise:
updating the corresponding company scores with the questionnaire responses received from the company representative; and
recalculating the statistical model based on the updated corresponding company scores.

10. The system of claim 4, wherein the operations further comprise:
updating the corresponding company scores with the calculated hierarchical group questionnaire score and the calculated overall company questionnaire score; and
calculating possible expected turnover averages associated with a range of corresponding company scores.

11. The system of claim 4, wherein the operations further comprise:
identifying outcome determinative factors of the difference in the workforce created by the average expected workforce turnover;
providing suggested changes, in response to identifying outcome determinative factors, to maintain a desired workforce.

12. A method for modeling attrition in a workplace, comprising:
receiving questionnaire responses to the questionnaire that elicits perception employee turnover factors of a hierarchical group of company representatives, wherein the questionnaire responses are provided by a plurality of company representatives and wherein the company representative can be selected from the group consisting of an executive level employee, a hiring manager, a supervisor or a combination thereof;
selecting questionnaire responses of the hierarchical group of company representatives;
calculating a hierarchical group questionnaire score;
calculating an overall company questionnaire score;
comparing the hierarchical group questionnaire score and overall company questionnaire score to a statistical model; and
determining an employee turnover propensity based on comparing the hierarchical group questionnaire score and overall company questionnaire score to a statistical model, wherein the employee turnover propensity indicates a likelihood that an employee will leave a particular job.

13. The method of claim 12, further comprising:
comparing the overall company questionnaire score to corresponding company scores; and
determining an average expected turnover based on comparing the overall company questionnaire score to corresponding company scores.

14. The method of claim 12, further comprising:
identifying outcome determinative factors of the difference in the workforce created by the average expected workforce turnover;
providing suggested changes, in response to identifying outcome determinative factors, to maintain a desired workforce.

15. The method of claim 12, wherein calculating a hierarchical group questionnaire score includes calculating a plurality of hierarchical group questionnaire scores for a plurality of hierarchical groups;
further comprising comparing the hierarchical group questionnaire scores; and
determining a variance between the hierarchical group questionnaire scores.

16. A computer-readable device comprising instructions, which when executed by a processor, cause the processor to perform operations comprising:
receiving questionnaire responses to the questionnaire that elicits perception employee turnover factors of a hierarchical group of company representatives, wherein the questionnaire responses are provided by a plurality of company representatives and wherein the company representative can be selected from the group consisting of an executive level employee, a hiring manager, a supervisor or a combination thereof;
selecting questionnaire responses of the hierarchical group of company representatives;
calculating a hierarchical group questionnaire score;
calculating an overall company questionnaire score;
comparing the hierarchical group questionnaire score and overall company questionnaire score to a statistical model; and
determining an employee turnover propensity based on comparing the hierarchical group questionnaire score and overall company questionnaire score to a statistical model, wherein the employee turnover propensity indicates a likelihood that an employee will leave a particular job.

17. The computer-readable device of claim 16, wherein the operations further comprise:
comparing the overall company questionnaire score to corresponding company scores; and
determining an average expected turnover based on comparing the overall company questionnaire score to corresponding company scores;
wherein determining an average expected turnover further comprises selecting an average expected turnover level from possible expected turnover averages associated with a range corresponding company scores;
wherein the average expected turnover is the employee turnover that is likely to occur given current circumstances of the company.

18. The computer-readable medium of claim 16, wherein the operations further comprise:
identifying outcome determinative factors of the difference in the workforce created by the average expected workforce turnover;
providing suggested changes, in response to identifying outcome determinative factors, to maintain a desired workforce.
